(19) United States
(12) Patent Application Publication
(10) Pub. No.: US 2026/0290637 A1
(43) Pub. Date: Sep. 24, 2026

(54) DEVICE AND METHOD FOR MECHANICALLY TESTING A TUBULAR NUCLEAR FUEL CLADDING SAMPLE UNDER ACCIDENT CONDITIONS

(71) Applicant: COMMISSARIAT A L'ÉNERGIE ATOMIQUE ET AUX ENERGIES ALTERNATIVES, Paris (FR)

(72) Inventor: Matthew BONO, Gif-sur-Yvette (FR)

(73) Assignee: COMMISSARIAT A L'ÉNERGIE ATOMIQUE ET AUX ENERGIES ALTERNATIVES, Paris (FR)

(21) Appl. No.: 19/175,491

(22) Filed: Apr. 10, 2025

(30) Foreign Application Priority Data
Apr. 10, 2024 (FR) FR2403705

(51) Int. Cl. G21C 17/06; G01N 3/12; G01N 3/18; G21C 17/00

(52) U.S. Cl. CPC G21C 17/06; G01N 3/12; G01N 3/18; G21C 17/001; G01N 2203/0019; G01N 2203/0069; G01N 2203/0226; G01N 2203/0232; G01N 2203/0252; G01N 2203/0274

(57) ABSTRACT

A device for mechanically testing a tubular nuclear fuel cladding sample under accident conditions includes: a deformable cylindrical core designed to be arranged in a mechanical test space by being inserted into the tubular sample, the deformable cylindrical core includes, at its periphery, a winding of an electrically conductive wire, the winding including a first connection end designed to be electrically connected to one of the compression pistons, and which includes a second connection end designed to be electrically connected to the other compression piston; and an electric generator designed to cause an electric current to flow between the two compression pistons and in the winding.

### TECHNICAL FIELD

The invention relates to the field of nuclear energy and relates more particularly to the field of plant safety. The invention relates to diagnostic and testing means used to analyse the mechanical behaviour of elements used in nuclear reactors.

A nuclear reactor typically comprises assemblies of tubular rods, referred to as cladding, in which the nuclear fuel pellets are stacked. This tubular cladding is where nuclear fission reactions that generate heat and fission products take place. This tubular cladding forms the first containment barrier against the spread of fuel and fission products.

For safety reasons, in a nuclear power plant, it is paramount to know the mechanical behaviour of the material of the tubular cladding, which is subjected to certain stresses representative of nominal service conditions and of particular incidental or accidental conditions. To obtain this information, specific mechanical and thermal tests are carried out in shielded cells on tubular cladding samples from reactors. Tests are also carried out in conventional laboratories on non-irradiated cladding samples.

The invention aims, in this context, to provide data on the mechanical behaviour of a tubular cladding sample (notably the deformation at break) subjected to conditions representative of those encountered in a reactor under accidental conditions, which are the most critical conditions.

### PRIOR ART

With the aim of replicating the actual nominal operating conditions of nuclear fuel cladding as closely as possible, patent applications FR3041097 and FR3101421 describe solutions for compressing a medium arranged inside a cladding sample, with the aim of applying biaxial mechanical stresses to the cladding. However, these devices do not enable mechanical tests under accident conditions, i.e. when the temperature increases very rapidly.

Other solutions propose combining mechanical testing elements with means for heating the cladding, so as to replicate accident conditions. However, these solutions enable temperature increase rates of the sample of around 100 to 200 °C per second, which are still far from actual accident conditions, in which the temperature can increase at rates of up to 1000 °C/s.

### DESCRIPTION OF THE INVENTION

The aim of the invention is to improve the devices and methods of the prior art.

To this end, the invention relates to a device for mechanically testing a tubular nuclear fuel cladding sample under accident conditions, this device comprising two compression pistons that can move relative to one another along a clamping axis and define a mechanical test space between them. In this device, the compression pistons comprise at least one electrically conductive portion. The device further comprises:
a deformable cylindrical core designed to be arranged in the mechanical test space, by being inserted into said tubular nuclear fuel cladding sample, this deformable cylindrical core comprising, at its periphery, a winding of an electrically conductive wire, this winding comprising a first connection end designed to be electrically connected to one of the compression pistons, and a second connection end designed to be electrically connected to the other compression piston;
an electric generator designed to cause an electric current to flow between the two compression pistons and in said winding.

According to another subject, the invention relates to a method for mechanically testing a tubular nuclear fuel cladding sample under accident conditions, using a device as described above. This method comprises the following steps:
placing a tubular nuclear fuel cladding sample in the test space, the deformable cylindrical core being inserted into the tubular nuclear fuel cladding sample, and said first connection end and second connection end being electrically connected to the corresponding compression piston;
a first sequence of increasing the temperature of the tubular nuclear fuel cladding sample by heating said winding by connecting the two compression pistons to the electric generator;
a second compression sequence in which the two compression pistons are disconnected from the electric generator and compress the cylindrical core.

The invention makes it possible to carry out mechanical tests on tubular nuclear fuel cladding samples under accident conditions, by virtue of movable compression pistons making it possible to subject the sample to mechanical deformations, whether monoaxial or biaxial, with a very rapid temperature increase of the sample, which are close to real accident conditions.

The invention makes it possible to carry out mechanical tests with a temperature increase rate of around 400 to 800 °C per second, this corresponding to a temperature increase rate representative of the conditions to which tubular nuclear fuel cladding may be subjected in the event of an accident.

The device according to the invention may comprise the following additional features, individually or in combination:
said winding is integrated into the material of the deformable cylindrical core;
the electrically conductive wire is provided with an electrically insulating sheath;
the electrically conductive wire is wound helically onto an external cylindrical face of the deformable cylindrical core, from one end to the other of the deformable cylindrical core along the clamping axis;
the first connection end and the second connection end comprise a first conductor and a second conductor, respectively, each passing through a portion of the corresponding compression piston;
the compression pistons each comprise an electrically conductive bar, designed to be connected to the electric generator, and an electrically insulating cylindrical buffer designed to be arranged against the deformable cylindrical core;
the deformable cylindrical core comprises an internal cylindrical portion made of a first material and fitted in an external annular portion made of a second material that is different from the first material;
the yield strength of the internal cylindrical portion is lower than the yield strength of the external annular portion;
the melting point of the external annular portion is higher than the melting point of the internal cylindrical portion;
the device comprises jaws designed to secure the ends of said tubular nuclear fuel cladding sample;
the jaws can be moved apart along the clamping axis.

The method according to the invention may comprise the following additional features, individually or in combination:
the first sequence is carried out by heating said winding by way of Joule heating;
the first sequence is carried out by induction heating of the tubular nuclear fuel cladding sample.

### PRESENTATION OF THE FIGURES

Other features and advantages of the invention will become apparent from the following non-limiting description, with reference to the appended drawings, in which:

FIG. 1 is a cross-sectional view of a mechanical testing device according to the invention, with a tubular nuclear fuel cladding sample in place;

FIG. 2 is a cross-sectional view of the device in FIG. 1, during mechanical testing;

FIG. 3 is a graph illustrating the temperature increase enabled by the device in FIGS. 1 and 2;

FIG. 4 is a graph illustrating the heating rate as a function of the temperature level, during use of the device in FIGS. 1 and 2.

Elements that are similar and common to the various embodiments bear the same reference numerals referring to the figures.

### DETAILED DESCRIPTION

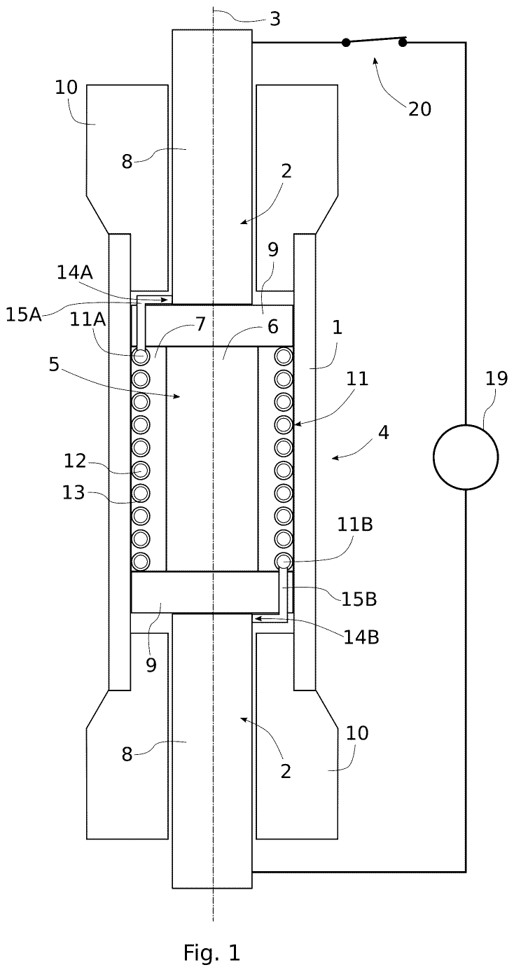

FIG. 1 is a schematic cross-sectional view of a mechanical testing device according to the invention. This device is intended for carrying out mechanical tests on a tubular nuclear fuel cladding sample under accident conditions.

The mechanical testing device is illustrated in a configuration in which it is ready to carry out a test, with a tubular nuclear fuel cladding sample 1 placed in the device and ready to be tested.

The mechanical testing device comprises two compression pistons 2 that can move relative to one another along a clamping axis 3. The compression pistons 2 define a mechanical test space 4, in which the tubular sample 1 will be able to be mechanically stressed following thermal conditioning, between them.

The mechanical testing device further comprises a cylindrical core 5 that is deformable. The cylindrical core 5 preferably consists of a ductile material or an assembly of ductile materials, so as to exhibit radial deformation (local increase in its diameter) when it is compressed along the clamping axis 3.

Particularly advantageously, in the present example, the cylindrical core 5 comprises an internal cylindrical portion 6 made of a material that deforms at a low compressive force at nominal operating temperatures. For example, the internal cylindrical portion 6 is in this case made of aluminium, which is very ductile with a low yield strength from 200 °C. The force required to compress the cylindrical core 5 thus remains moderate so as not to damage the compression pistons 2, and does not require excessively large pressing means.

The cylindrical core 5 further comprises, in this example, an external annular portion 7 in which the internal cylindrical portion 6 is fitted. Preferably, the external annular portion 7 is made of a material that withstands a higher temperature than the internal cylindrical portion 6. For example, the external annular portion 7 is made of copper, which has a melting point of around 1085 °C. At the temperature of the test, the external annular portion 7 must have a high ductility and must deform at a low compressive force, this being the case in this example with the aluminium/copper pair. Any other suitable pair of materials, one of which has a higher melting point than the other, may be envisaged.

The compression pistons 2 are arranged on either side of the cylindrical core 5 so that their clamping is designed to compress the cylindrical core 5 axially (i.e. along the clamping axis 3).

Preferably, the portion of the compression pistons 2 that is designed to come into contact with the cylindrical core 5 has substantially the same diameter as the cylindrical core 5.

In the present example, the compression pistons 2 comprise a bar 8, which is electrically conductive, and a cylindrical buffer 9 that is electrically insulating. The bar 8 is, for example, metallic. The diameter of the cylindrical buffer 9 is substantially equal to the diameter of the cylindrical core 5. In a variant, the cylindrical buffer 9 may also be conductive and comprise an insulating coating on its face in contact with the cylindrical core 5.

The mechanical testing device may further comprise means for positioning the tubular sample 1. In this example, these means consist of jaws 10 that are designed to be attached to each end of the tubular sample 1, for example by clamping, screw-fastening, welding, or any other securing means.

The jaws 10 thus make it possible, in addition to holding the tubular sample 1, to participate in the mechanical test by securing or axially stretching the tubular sample 1 if a biaxial mechanical test is desired.

For the implementation of a test, the tubular sample 1 is prepared from new (for a characterization test) or used fuel cladding. Nuclear reactors conventionally comprise fuel cladding with a length of around 4 metres and a diameter of around 1 centimetre. The tubular sample 1 can be prepared by cutting fuel cladding. In one example of embodiment, the tubular sample 1 prepared in this way has a length of around 3 cm (along the clamping axis 3 in FIG. 1), for a cylindrical core 5 with a length of around 14 mm.

The tubular sample 1 is arranged in the mechanical test space 4, and the cylindrical core 5 is inserted into the tubular sample 1. In this example, the jaws 10 are furthermore attached to each end of the tubular sample 1.

The cylindrical core 5 further comprises, on its periphery, a winding 11 formed by an electrically conductive wire 12. In this example, the wire 12 is wound in a spiral around the external periphery of the cylindrical core 5. The wire 12 is thus wound helically from one end to the other of the cylindrical core 5, i.e. over its entire length along the clamping axis 3.

In this example, the wire 12 is integrated into the material of the external cylindrical face of the cylindrical core 5 as illustrated in FIG. 1. In this example, with the cylindrical core 5 consisting of an internal cylindrical portion 6 and an external annular portion 7, the wire 12 is embedded in the material of the external annular portion 7.

The winding 11 thus forms a coil wound onto the cylindrical core 5.

Alternative arrangements can be envisaged in order to form such a coil with the winding 11. The wire 12 may be, for example, arranged in a helical groove formed on the external surface of the cylindrical core 5, by means of an additive manufacturing or machining method. The wire 12 can moreover be wound directly onto the cylindrical core 5. The wire 12 may have a circular cross section, as in the example in FIG. 1, or, for example, a rectangular or flattened cross section. The wire 12 may, for example, be a conductive strip wound onto the surface of the external cylindrical face of the cylindrical core 5. The wire 12 may moreover be in the form of a sheet or of a coating on the external surface of the cylindrical core 5.

The wire 12 may be furthermore provided with an electrically insulating sheath 13. The sheath 13 is designed to withstand high temperatures and is, for example, produced by a ceramic coating of the wire 12.

The coil formed by the winding 11 has a first end turn 11A and a second end turn 11B at the opposite end. Each of these end turns 11A, 11B is electrically connected to one of the compression pistons 2 by a connection end 14A, 14B.

In the present example, the first connection end 14A of the winding 11 comprises a first conductor 15A, which passes through the cylindrical buffer 9 and which is electrically connected to the corresponding bar 8, which is conductive.

Similarly, at the other end of the winding 11, the second connection end 14B of the winding 11 comprises a second conductor 15B, which passes through the cylindrical buffer 9 and is electrically connected to the corresponding bar 8.

An electrical circuit can thus be established between the two compression pistons 2, through the winding 11 forming a coil. FIG. 1 schematically illustrates an electric generator 19 connected in this way to the two compression pistons 2. A switch 20 schematically shows the closure of the circuit so that a suitable alternating or direct current (see first and second embodiments hereinbelow) flows through the winding 11 so as to cause the temperature of the tubular sample 1 to increase.

The connection between the connection ends 14A, 14B and the compression pistons 2 may be established using any means, such as connectors, electrical contacts, etc. It is also possible for this connection to be established by soldering or crimping once the assembly is in place.

Starting from this assembly in FIG. 1, the tubular sample 1 being placed in the mechanical testing device, with the winding 11 electrically connected to the compression pistons 2, the mechanical testing method can be implemented.

In a first sequence, referred to as temperature-increase sequence (illustrated in FIG. 1, with the schematic switch 20 closed), the tubular sample 1 will first of all be subjected to a thermal stress caused by a rapid increase in the temperature of its wall by virtue of the winding 11.

According to a first embodiment, the winding 11 is heated by way of Joule heating and heats the wall of the tubular sample 1 when it increases in temperature. In this case, the wire 12 has an electrical resistance adapted to a Joule-heating apparatus, and a high direct current (for example several tens of amperes) is applied between the two compression pistons 2. In one example of embodiment, the wire 12 has a diameter of around 0.5 to 1 mm.

According to a second embodiment, the winding 11 heats the wall of the tubular sample 1 by induction. In this case, a current designed to create an induction phenomenon in the tubular sample is applied between the two compression pistons 2, for example a high-frequency alternating current.

These two embodiments may be combined, for example by driving the electric generator 19 alternately in a Joule-heating mode (with a high intensity) and in an induction-heating mode (by a high-frequency alternating current).

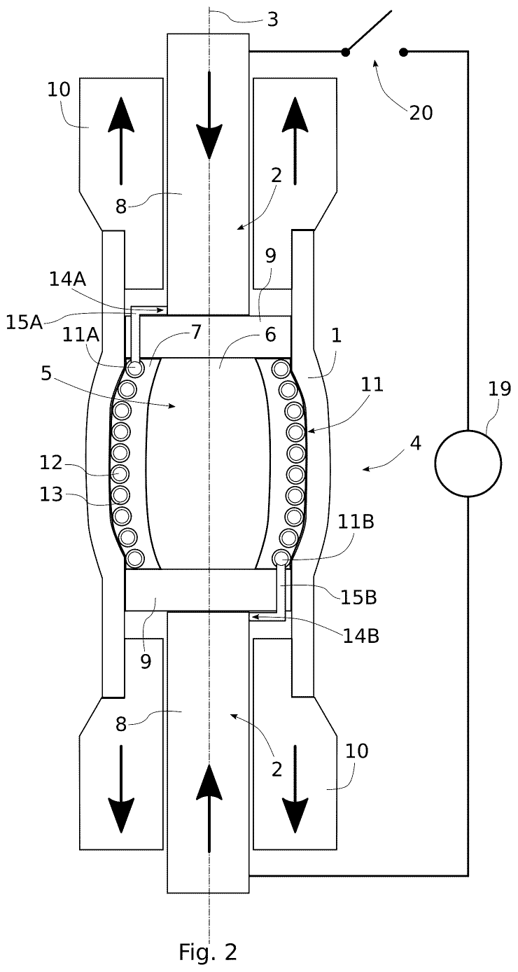

In a second sequence, referred to as compression sequence (illustrated in FIG. 2, with the schematic switch 20 open), as soon as the tubular sample 1 has undergone the desired increase in temperature, the compression pistons 2 are then urged towards one another and compress the cylindrical core 5. The compression pistons 2 are, for example, moved by a press.

FIG. 2 illustrates the result of this compression sequence.

The cylindrical core 5 deforms radially and its diameter increases, thus stressing the walls of the tubular sample 1 as the expanded nuclear fuel would. This deformation takes place while, on the one hand, the tubular sample 1 has been brought to a high temperature and, on the other hand, this heating has also been carried out at a high rate, thereby influencing the mechanical characteristics of the tubular sample 1 in a manner close to actual accident conditions.

The invention is compatible with a biaxial mechanical test in which, while the compression pistons 2 are urged towards one another, the jaws 10 are also urged apart from one another so that, in addition to being radially deformed, the tubular sample 1 is also deformed axially by being stretched between the two jaws 10.

In this second sequence, with the tubular sample 1 having already been brought to the desired temperature, the current flowing through the winding 11 is cut off. During the compression of the cylindrical core 5, it is possible for the winding 11 to be damaged, or even destroyed, as well as the connection ends 14A, 14B, without affecting the mechanical test. In such a case of destruction, the cylindrical core 5 is then a consumable part that is renewed for each mechanical test.

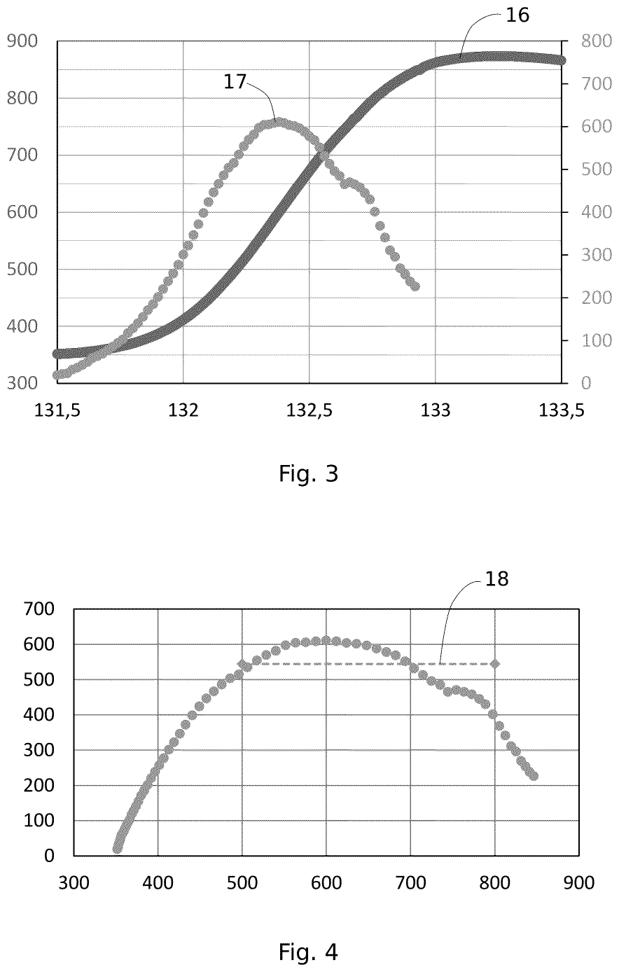

FIGS. 3 and 4 relate to an example of a mechanical test carried out with a tubular sample 1 that is 3 cm long, a cylindrical core 5 that is 14 mm long and has a diameter adjusted to the internal diameter of the tubular sample 1, and a wire 12 with a diameter of 0.8 mm. In this example, the wire 12 is made of copper-nickel. This example test is carried out with the winding 11 being heated by way of Joule heating. In this example, the tubular sample 1 was able to be heated during the first sequence to a temperature of around 800 °C, with heating rates of greater than 500 °C/s.

FIG. 3 illustrates both the temperature in °C measured on the tubular sample 1 (curve 16 and values on the y-axis on the left-hand side of the graph) and the heating rate in °C/s (curve 17 and values on the y-axis on the right-hand side of the graph), as a function of time in seconds (on the x-axis).

Firstly, the tubular sample 1 was heated to 350 °C in order to reproduce its operating temperature under the nominal operating conditions of the nuclear reactor. After a plateau at 350 °C, a high current is passed (at 131.5 seconds) through the wire 12, which is rapidly heated by way of Joule heating, then the current is cut off when the tubular sample 1 reaches 800 °C. After the current has been cut off, a residual increase in temperature brings the tubular sample 1 up to 870 °C.

The 0.8 mm diameter of the wire in this example presents a good compromise between a small diameter (if the diameter of the wire 12 is too small, the wire 12 may melt before heating the tubular sample 1) and too large a diameter, which would not make it possible to form the winding 11.

The curve 17 shows the variation in the heating rate, this being a parameter of primary importance. The highest heating rate reached is greater than 600 °C/s and is reached at a temperature of 600 °C. From this temperature, the radiation of the external surface of the tubular sample 1 seems to become significant, and the heating rate decreases. The heating rate then drops sharply to 800 °C when the current is cut off.

FIG. 4 illustrates this same phenomenon of the variation in the heating rate. The graph in FIG. 4 shows the variation in the heating rate in °C/s as a function of the temperature in °C reached.

The heating rate is approximately 400 °C/s to 800 °C/s, and the average value (dotted line segment 18) over the temperature range 500 °C-800 °C is 540 °C/s.

Variant embodiments may be implemented. Notably, the jaws 10, which are required for a biaxial test, are optional if such a biaxial test is not desired. The jaws 10 may also consist of any other mechanical means designed to axially stretch the tubular sample 1.

The winding 11 may also have winding contours other than a helical contour as described hereinabove. It can describe shapes around the cylindrical core 5, especially if it acts by way of Joule heating.

1. A device for mechanically testing a tubular nuclear fuel cladding sample under accident conditions, the device comprising:
two compression pistons that can move relative to one another along a clamping axis and define a mechanical test space between them, the compression pistons comprise at least one electrically conductive portion
a deformable cylindrical core designed to be arranged in the mechanical test space, by being inserted into said tubular nuclear fuel cladding sample, this deformable cylindrical core comprising, at its periphery, a winding of an electrically conductive wire, this winding comprising a first connection end designed to be electrically connected to one of the compression pistons, and a second connection end designed to be electrically connected to the other compression piston; and
an electric generator designed to cause an electric current to flow between the two compression pistons and in said winding.

2. The device according to claim 1, wherein said winding is integrated into the material of the deformable cylindrical core.

3. The device according to claim 1, wherein the electrically conductive wire is provided with an electrically insulating sheath.

4. The device according to claim 1, wherein the electrically conductive wire is wound helically onto an external cylindrical face of the deformable cylindrical core, from one end to the other of the deformable cylindrical core along the clamping axis.

5. The device according to claim 1, wherein the first connection end and the second connection end comprise a first conductor and a second conductor, respectively, each passing through a portion of the corresponding compression piston.

6. The device according to claim 1, wherein the compression pistons each comprise an electrically conductive bar, designed to be connected to the electric generator, and an electrically insulating cylindrical buffer designed to be arranged against the deformable cylindrical core.

7. The device according to claim 1, wherein the deformable cylindrical core comprises an internal cylindrical portion made of a first material and fitted in an external annular portion made of a second material that is different from the first material.

8. The device according to claim 7, wherein the yield strength of the internal cylindrical portion is lower than the yield strength of the external annular portion.

9. The device according to claim 7, wherein the melting point of the external annular portion is higher than the melting point of the internal cylindrical portion.

10. The device according to claim 1, further comprising jaws designed to secure the ends of said tubular nuclear fuel cladding sample.

11. The device according to claim 10, wherein the jaws can be moved apart along the clamping axis.

12. A method for mechanically testing a tubular nuclear fuel cladding sample under accident conditions, using a device according to claim 1, the method comprising:
placing a tubular nuclear fuel cladding sample in the test space, the deformable cylindrical core being inserted into the tubular nuclear fuel cladding sample, and said first connection end and second connection end being electrically connected to the corresponding compression piston;
a first sequence of increasing the temperature of the tubular nuclear fuel cladding sample by heating said winding by connecting the two compression pistons to the electric generator; and
a second compression sequence in which the two compression pistons are disconnected from the electric generator and compress the cylindrical core.

13. The method according to claim 12, wherein the first sequence is carried out by heating said winding by Joule heating.

14. The method according to claim 12, wherein the first sequence is carried out by induction heating of the tubular nuclear fuel cladding sample.
